(19) United States
(12) Patent Application Publication
(10) Pub. No.: US 2003/0236778 A1
(43) Pub. Date: Dec. 25, 2003

(54) Drawing search support apparatus and drawing search method

(75) Inventors: Daiki Masumoto, Kawasaki (JP); Susumu Endo, Kawasaki (JP); Yusuke Uehara, Kawasaki (JP); Shuichi Shiitani, Kawasaki (JP); Takayuki Baba, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/383,659

(22) Filed: Mar. 10, 2003

(30) Foreign Application Priority Data
Jun. 25, 2002 (JP) 2002-184118

(51) Int. Cl. G06F 7/00

(52) U.S. Cl. 707/3

(57) ABSTRACT

When a user designates drawing information to be searched, a component drawing region is extracted from each piece of drawing information, and an icon that highlights a line drawing in the extracted region is generated. Then, an icon is arranged in a virtual space based on the feature amount of the corresponding drawing information, and displayed on a screen.

### BACKGROUND OF THE INVENTION

1. Field of the Invention

The present invention relates to a method of searching for desired information from among a great deal of drawing information, and an apparatus for supporting such a search operation. The present invention is used in a field which requires a search for documents that includes drawings, such as a search for patent documents, machine drawings, electronic circuit drawings, etc.

2. Description of the Related Art

In a conventional drawing search operation, information that matches a keyword inputted by a user is searched for using a keyword search technology that targets the attribute data of drawing information. The titles or abstracts obtained by this keyword query operation are listed in matching order to be offered to the user. In this technology, only a small amount of information is offered if the keyword is appropriately inputted, and accordingly the desired information can be easily detected.

If the keyword does not represent the user's search intention appropriately, or the user's search intention itself is not clear, the list of features of information to be presented becomes potentially large. Consequently, the order of the presented information does not always match the user's intention. In some cases, the information is omitted from the list of retrieved results. Additionally, if relevant attribute data is not affixed to drawing information, the information about the drawing cannot be searched.

Alternatively, an image search technology that uses an image query to search for similar images has been recently used for searching for drawing. In this method, a user designates a certain image to be the image query, a system searches for images similar to this image, displays a resulting list of retrieved similar images in similarity order, and offers this list to the user. A general user, however, cannot easily designate an appropriate query image. Furthermore, only image characteristics such as the color of images, cursory layout information, etc. can be used as criteria for similarity matching between images. Therefore, the displayed list of retrieved results does not always match the user's intention.

The following is a summary of the above-mentioned problems.

(1) It is difficult to designate an appropriate keyword to narrow down drawing information.

(2) In the case where relevant attribute data is not affixed to drawing information, a keyword search cannot be performed.

(3) It is difficult to designate an appropriate query image to narrow down drawing information.

### SUMMARY OF THE INVENTION

It is an object of the present invention to provide a drawing search support apparatus for easily searching desired information from among a great deal of drawing information, and also a method for executing such a drawing search.

The first drawing search support apparatus of the present invention is provided with a generation device, an arrangement device, a display device, a change device, and a storage device. This apparatus supports the operation of searching for desired drawing information from among a plurality of pieces of drawing information.

The generation device extracts a drawing region from among image data for each of the plurality of pieces of drawing information, and generates an icon highlighting a line drawing in the extracted drawing region. The arrangement device determines an arrangement position of each icon in a virtual space based on a feature amount of a corresponding piece of drawing information. The display device simultaneously displays icons for the plurality of pieces of drawing information arranged in the virtual space.

The second drawing search support apparatus of the present invention is provided with a generation device, an arrangement device, and a transmission device. This apparatus supports the operation of searching for desired drawing information from among the plurality of pieces of drawing information.

The generation device extracts a drawing region from among image data for each of the plurality of pieces of drawing information, and generates an icon highlighting a line drawing in the extracted drawing region. The arrangement device determines an arrangement position of each icon in a virtual space based on a feature amount of a corresponding piece of drawing information. The transmission device transmits display data for simultaneously displaying icons for the plurality of pieces of drawing information arranged in the virtual space.

The third drawing search support apparatus of the present invention is provided with a storage device, a generation device, an arrangement device, and a display device. This apparatus supports the operation of searching for desired drawing information from among a plurality of pieces of drawing information.

The storage device stores a predetermined icon image prepared in advance for each type of drawing information. The generation device obtains an icon image corresponding to the type of each of the plurality of pieces of drawing information, and generates an icon using the obtained icon image. The arrangement device determines an arrangement position of each icon in a virtual space based on a feature amount of a corresponding piece of drawing information. The display device simultaneously displays icons for the plurality of pieces of drawing information arranged in the virtual space, and displays additional information showing the content that is specific to each piece of drawing information, in the vicinity of each icon.

### BRIEF DESCRIPTION OF THE DRAWINGS

FIG. 1 shows the configuration of a drawing search support apparatus of the present invention;

FIG. 2 shows a drawing display process;

FIG. 3 shows the configuration of another drawing search support apparatus;

FIG. 4 shows a flowchart of an icon generating process;

FIG. 5 shows an icon with a reduced image;

FIG. 6 shows the first icon arrangement;

FIG. 7 shows the second icon arrangement;

FIG. 8 shows the display method of drawing information;

FIG. 9 shows the re-arrangement of icons;

FIG. 10 shows the first labeled icon;

FIG. 11 shows the second labeled icon;

FIG. 12 shows a predetermined icon;

FIG. 13 shows the third labeled icon;

FIG. 14 shows a network system;

FIG. 15 shows the configuration of an information processing apparatus; and

FIG. 16 shows recording media.

### DESCRIPTION OF THE PREFERRED EMBODIMENT

Provided below is the detailed explanation of the preferred embodiment of the present invention with reference to the drawings.

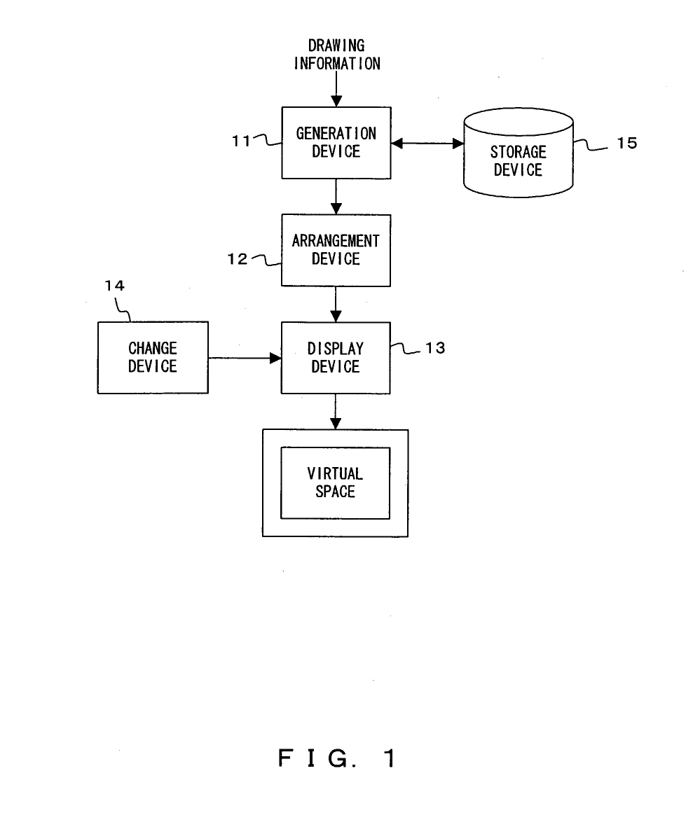

FIG. 1 shows the configuration of a drawing search support apparatus of the present invention. The drawing search support apparatus shown in FIG. 1 is provided with a generation device 11, an arrangement device 12, a display device 13, a change device 14, and a storage device 15. This apparatus supports the operation of searching for desired drawing information from among a plurality of pieces of drawing information.

The generation device 11 extracts a drawing region from among image data for each of the plurality of pieces of drawing information, and generates an icon highlighting a line drawing in the extracted drawing region. The arrangement device 12 determines an arrangement position of each icon in a virtual space based on the feature amount of the corresponding piece of drawing information. The display device 13 simultaneously displays icons for the plurality of pieces of drawing information arranged in the virtual space.

The drawing region of drawing information corresponds to a region in which a line drawing is depicted. In the case of a machine drawing, for example, the shape of a component is depicted in the drawing region. When an icon is generated from the image data for drawing information, the image is not simply reduced, but a drawing region is extracted from the image data and the line drawing is highlighted by thickening or coloring lines included in the drawing region. Thus, the line drawing in the reduced image can be easily recognized, thereby enhancing the efficiency of a search operation. Therefore, a user can easily search for an icon of his or her desired drawing information while looking at the displayed virtual space.

A change device 14 changes a user's visual point in the displayed virtual space. Since such a function is provided, a user can search for his or her desired information while freely moving his or her visual point in the virtual space.

The storage device 15 (icon database) stores a predetermined icon image that is prepared in advance for each type of drawing information. The generation device 11 obtains an icon image corresponding to the type of each piece of drawing information from the storage device 15, and generates an icon using the obtained icon image. The display device 13 displays a virtual space in which icons for a plurality of pieces of drawing information, generated using the predetermined icon image, are arranged, and it displays additional information (label) showing the content that is specific to each piece of drawing information, in the vicinity of each icon.

An icon with a stable picture quality can be displayed by preparing in advance an icon image corresponding to the type of drawing information. Furthermore, the content that is specific to the drawing information can be offered to a user by displaying the additional information in the vicinity of the corresponding icon. Then, a user selects either the icon generated from the image data for the drawing information or the icon generated using a predetermined icon image, so that he or she can manipulate the drawing search support apparatus to display the selected icon.

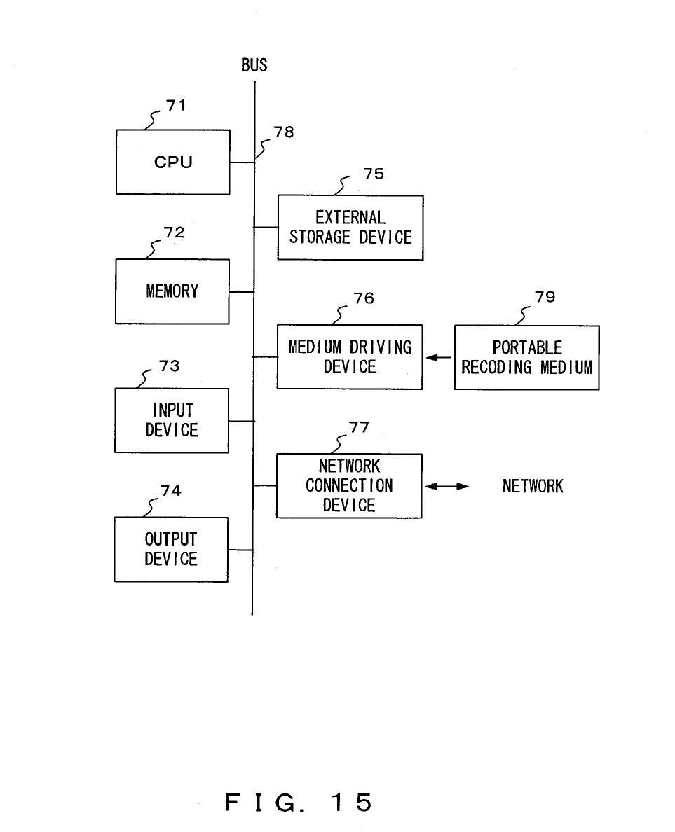

The generation device 11, the arrangement device 12, and the change device 14 shown in FIG. 1 correspond to, for example, a CPU (Central Processing Unit) 71 and a memory 72 shown in FIG. 15, which will be described later. The display device 13 shown in FIG. 1 corresponds to, for example, the output apparatus 74 shown in FIG. 15, while the storage device 15 corresponds to, for example, an external storage apparatus 75 shown in FIG. 15.

In the present preferred embodiments, drawing information is offered to a user as much as possible using a computer, thereby enable a user to search for his or her desired information from among the information. In the case where the drawing information to be searched for is composed of the image data and the attribute data of a drawing, a user can with relative ease detect his or her desired information from among the great amount of images offered, by listing and displaying the image data as icons which are well browsable.

Furthermore, by arranging the related icons in close proximity to each other based on the feature amount extracted from drawing information, or by arranging the image with a specific feature in a specific position, a user's search efficiency can be enhanced.

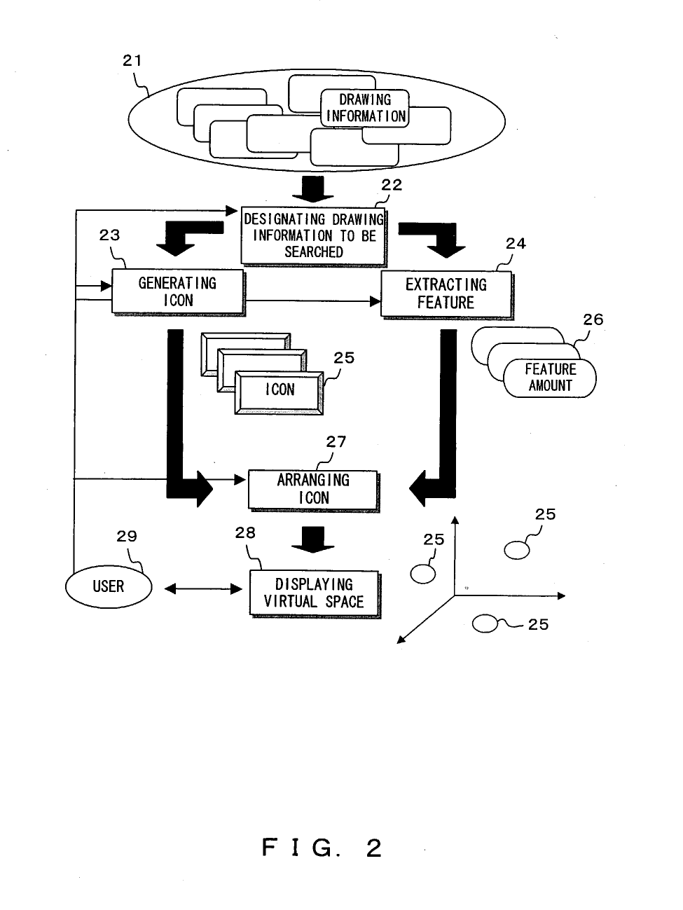

FIG. 2 shows the flow of a drawing display process performed by a drawing search support apparatus of a preferred embodiment. This process includes the following functions:

### Designating Function of a Search Target (22)

A user 29 designates a drawing information group 21 composed of the image data and the attribute data for a drawing as a search target. For designation, there are two methods; one method is to designate a directory for storing the drawing information, and a second method is to designate a group of drawing information obtained by a search using an existing information search device (for example, keyword search engine).

### Icon Generation (Information Visualization) Function (23)

Each piece of the drawing information selected as a search target is converted into an icon for visibly expressing the content of the information using an information visualization device. For conversion, a manual conversion method and an automatic conversion method are adopted. An automatic conversion method extracts a component which is important when a user wishes to distinguish his or her desired drawing from among drawing data (in the case of a machine drawing, the outline or other components in the drawing), and then the method converts the extracted component into a thumbnail image which highlights the component.

### Feature Extraction Function (24) (for Determining the Arrangement)

A feature amount 26 for determining the arrangement position of an icon 25 is extracted from the respective pieces of drawing information. The feature amount 26 is extracted for each of media included in each piece of drawing information.

In the case of numeric value attribute data having an order like a date, the numeric value is extracted as the feature amount 26. In the case of text attribute data such as a title or an explanation document, a feature vector for each text is extracted as the feature amount 26.

In the case of a tf-idf (term frequency-inverse document frequency) method, a feature vector having the tf-idf value of a word as an element is extracted from each text by selecting in advance a set of words that is thought to be effective for characterizing a text, by measuring the degree of relative importance of each word, and by listing the obtained degrees of importance. In the case where a text can be divided into a plurality of regions, a plurality of feature vectors can be also extracted.

In the case of image data, a color characteristic, a texture characteristic, a frequency characteristic (Fourier characteristic or DCT (Discrete Cosine Transform) characteristic), a shape characteristic, or the like is extracted as the feature amount 26. In the case that an image can be divided into a plurality of regions, a plurality of image features can be extracted. In this case, a piece of drawing information can be expressed by a plurality of icons by preparing different icons for respective image features or copying the same icon.

### Icon Arrangement Function (27)

The feature amount 26 corresponding to each piece of drawing information is generally a vector in a space of a higher order. The icon 25 is arranged within a virtual space which is on or below the three dimension in a computer, in order to visualize the distribution status for the case that all the pieces of drawing information designated as search targets are plotted on the corresponding space of higher order. Each coordinate axis of the virtual space corresponds to a part of the feature amount 26, and accordingly the icon 25 can be arranged on the basis of the corresponding feature amount 26. For the arrangement decision, principal component analysis, multi-dimensional scaling analysis, etc, that is, statistical methods, or a Self Organizing Map (SOM), that is, a kind of a neural network are used.

### Virtual Space Display Function (28)

A virtual space in which the icons 25 are arranged is displayed. At this time, the user 29 changes his or her visual point in the virtual space using computer graphics technology, and accordingly the user can freely walk through the space, or can fly through the space. This significantly helps the user 29 to search for the drawing information. When the user 29 clicks the icon 25 using a pointing device such as a mouse, etc., the original drawing information is displayed.

Furthermore, the drawing search support apparatus can activate another apparatus to display a virtual space via a communication network, such as the Internet, intranet, etc. In this case, the data of the icons 25 is transmitted to another apparatus via the network.

The user 29 can also return to an arbitrary function while searching for his or her desired information in the displayed virtual space. Specifically, the user 29 can re-designate the group of search targets, can switch over the icon 25 corresponding to the same drawing information to another icon, or can change the arrangement of an icon by switching over the feature for arrangement decision to another feature.

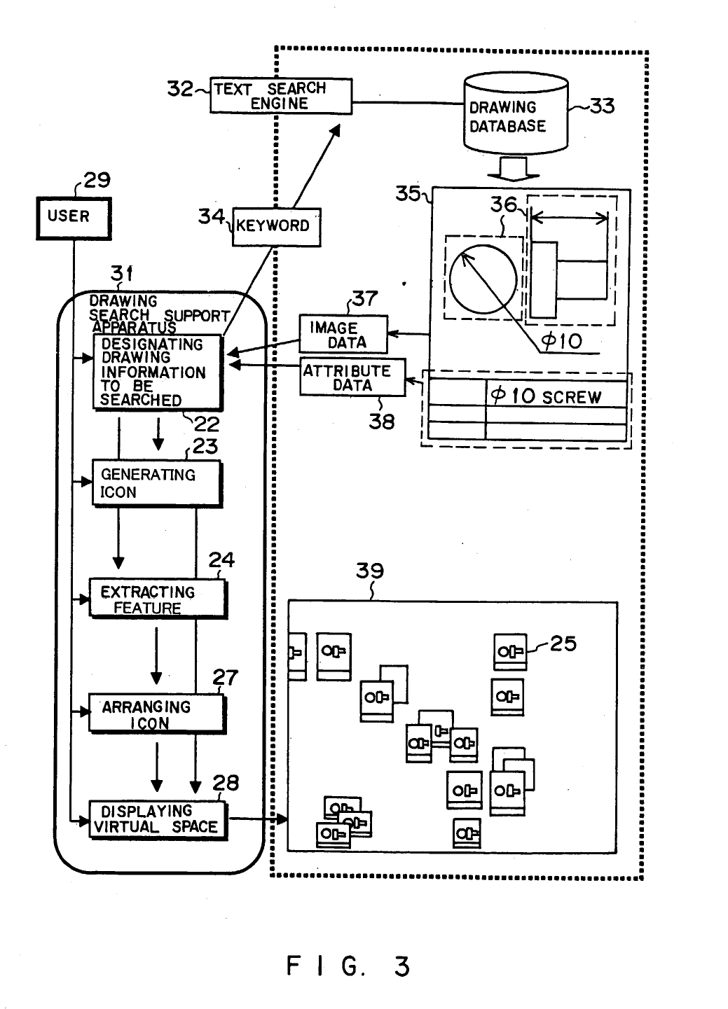

FIG. 3 shows a drawing search support apparatus of supporting the search for a machine drawing. The drawing search support apparatus 31 shown in FIG. 3 corresponds to a computer system for implementing the programs that consist of the respective functions, for example, shown in FIG. 2. The following is a flow of the drawing display process performed by the drawing search support apparatus 31.

Designation of Search Target (22)

The user 29 designates a group of the plurality of pieces of drawing information as a search target. For example, in the case that the user 29 inputs “a screw” as a keyword 34, a text search engine 32 retrieves the drawing information that is stored in a drawing database 33 using the keyword 34, and it selects matched drawing information 35 as a search target. Image data 37 and attribute data 38 of the selected drawing information 35 are input to the drawing search support apparatus 31.

Icon Generation (23)

The drawing search support apparatus 31 converts each piece of the drawing information 35 that is selected as a search target, into the icon 25. At this time, the contents of the attribute data 38 are analyzed. If a numerical value for attribute data exists in the attribute data 38, the numerical value and the attribute name are extracted as a pair.

Furthermore, if text attribute data exists in the attribute data 38, the word(s) (keyword(s)) that characterizes the drawing information 35 is extracted from the data. Specifically, with reference to the text attribute data in all the pieces of the drawing information that is to be searched for, a keyword is extracted either by the method using the mutual information amount, by the method using the Chi-square value, or by the tf-idf method and by using a technical term dictionary or rules as occasion demands.

A region division process is performed on the image data 37, and a component drawing region 36 (region in which a line drawing of a component is depicted) is distinguished from the other regions, so that the component drawing region 36 can be extracted. Then, the icon 25 is generated by using the extracted numerical values, the keywords, the images from the component drawing region 36, etc.

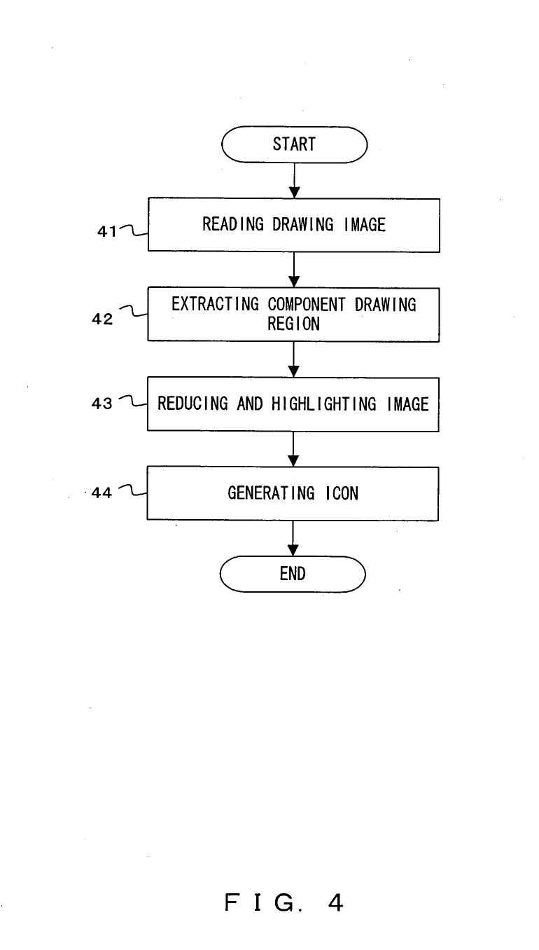

FIG. 4 is a flowchart showing an example of such an icon generating process. Firstly, the drawing search support apparatus 31 reads both the image data 37 and the attribute data 38 as a drawing image (41). In the case that the given drawing is a paper drawing, the drawing is converted into a digital image using a scanner, and then the digital image is binalized to be loaded into a main memory unit. In the case that the given drawing is a digital image, this image is binalized to be loaded into the main memory unit.

Next, the loaded drawing image is analyzed, and the component drawing region 36 is automatically or semi-automatically extracted from the drawing image (42) The following is the explanation of an automatic extraction method and a semi-automatic extraction method.

(1) Automatic Extraction Method

For this process, various methods can be adopted as described in section 3.5 (2) (pp.1089) of the following document.

Document 1:

Akio Tojo, Takanori Sato, “Automatic Recognition and Interpretation of Sketches and Drawings”, Information Processing, vol. 24, no. 9, pp. 1086-1094, 1983.

These are a method for evaluating the frequency of appearances of a black run and a white run, a method for evaluating the feature amounts of frequency distribution and peripheral distribution of a density function and run-length, and a method of using two-dimensional Fourier transformation and the like.

According to the method described in section 3.7 of document 1 (pp. 1090), drawing region 36 can be extracted by dividing the drawing into a plurality of regions, extracting a line segment or the like for each region and collecting the obtained results.

Furthermore, according to the method described in chapter 4 (pp. 162-165) of the following document, the component drawing region 36 can be extracted by evaluating the frequency of appearances of a black run and a white run in the binary image.

Document 2:

Michihiko Mino and Shunichi Kato, “Document Image Processing”, O plus E separate volume 1986/11 (Mikio Takagi, Junichiro Toriwaki and Hideyuki Tamura, “Latest Trend of Image Processing Algorithm”), pp. 158-171, New technology communications, 1986.

(2) Semi-Automatic Extraction Method

A method of directly presenting a component drawing region to a system, through tracing the outline of a component by the user 29 or a method of indirectly presenting a component drawing region to a system by clicking the inside of a component drawing region by the user using a pointing device, is conceivable. The latter case uses a method of extending the region from a point designated by the user 29 up to a boundary line, as is described in chapter 2.2 (pp. 59-60) of the following document.

Document 3:

Keiichi Abe and Hideo Ogawa, “Processing of Geometrical Characteristic (2)”, O plus E separate volume 1986/11 (Mikio Takagi, Junichiro Toriwaki and Hideyuki Tamura, “Latest Trend of Image Processing Algorithm”), pp. 58-72, new technology communications, 1986.

Next, the drawing search support apparatus 31 reduces a drawing image and highlights its component drawing region (43). When a drawing image is reduced, in many cases, pixels are simply thinned or a pixel is interpolated by the values of peripheral pixels. If a drawing is reduced in such a way, however, the outline of its component becomes thin or breaks up depending on the circumstances. Therefore, the user 29 is barely able to confirm the shape of the component by sight.

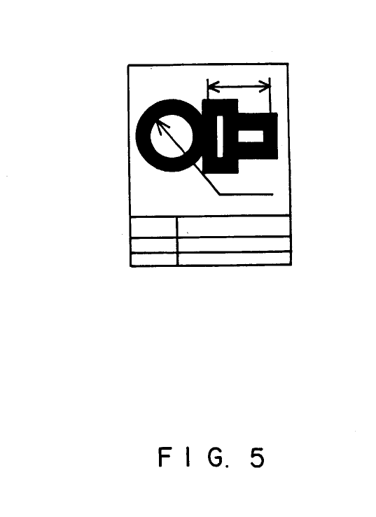

Thereupon, the shape of a component is highlighted by thickening or coloring the line of the component in the drawing region, and then an icon image is generated using the highlighted line (44). For example, the icon image as shown in FIG. 5 is generated from the drawing information 35 of “a screw” shown in FIG. 3. Thus, by extracting the component drawing region 36 and highlighting the line, a shape of the component within the reduced drawing image can be easily recognized.

Feature Extraction (24)

The drawing search support apparatus 31 extracts the feature amount 26 from the image data 37 and the attribute data 38. In the case of numerical value attribute data, for example, the numerical value is directly used as the feature amount 26, while in the case of text attribute data, a feature vector is extracted using the tf-idf method, etc. In the case of image data, a color characteristic, a texture characteristic, a frequency characteristic, a shape characteristic, etc. are extracted.

Icon Arrangement (27)

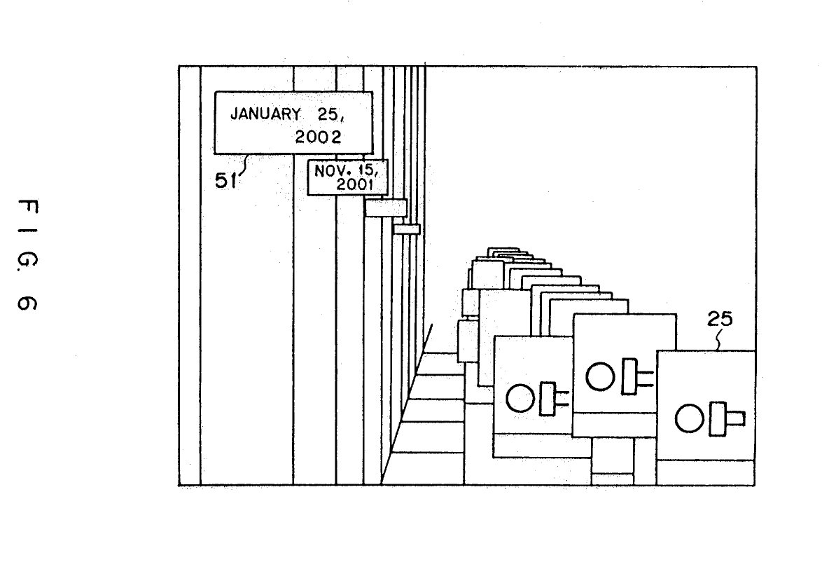

The drawing search support apparatus 31 arranges icons 25 in a virtual space, on the basis of the extracted feature amounts 26. In the case that the feature amount 26 is a numerical value, the icons 25 are arranged in descending order or in ascending order, for example, in a row-first manner from the top of the left of a screen. In some cases, the icons 25 are arranged in numerical order in the virtual space from the back of the screen as shown in FIG. 6. In FIG. 6, a preparation date 51 for the drawing is extracted as its feature amount 26, and the icons 25 are thus arranged in numerical order from the back of the screen.

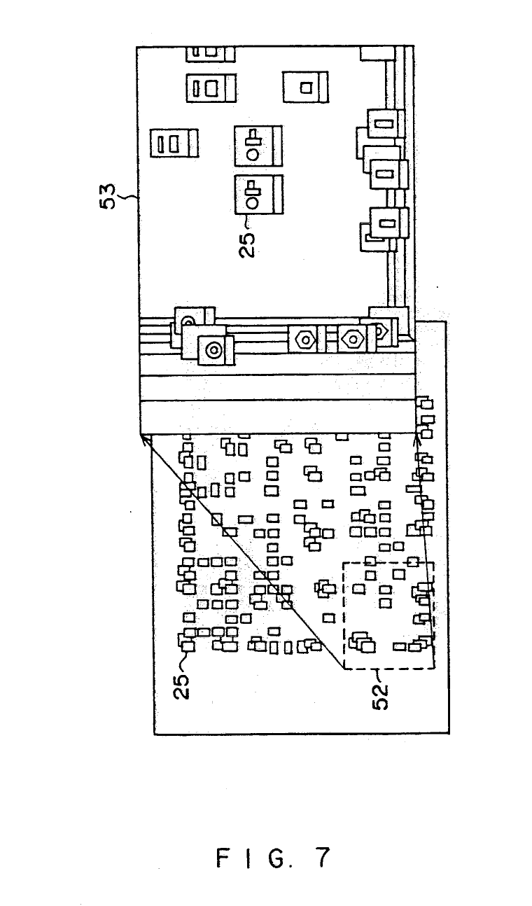

In the case that the feature amount 26 is a text characteristic or an image characteristic, the dimension of a feature vector is generally high, so that the high number of dimension should be reduced. To reduce the dimension of the feature vector, KL expansion, which projects data in a direction where many data can be seen scattered, etc. is used. By enabling an icon 25 to be arranged on a two-dimensional plane by the Self Organizing Map using the obtained low dimensional feature vector, all the icons 25 can be arranged in such a way that a plurality of pieces of similar drawing information can be gathered in close proximity to each other as shown in FIG. 7.

The image feature of a drawing is extracted as the feature amount 26, in FIG. 7, and the icons 25 are arranged so as to gather in close proximity a plurality of pieces of the drawing information of components that have similar shapes. When the user 29 instructs that the display of a region 52 be expanded, another screen 53 is displayed.

Virtual Space Display (28)

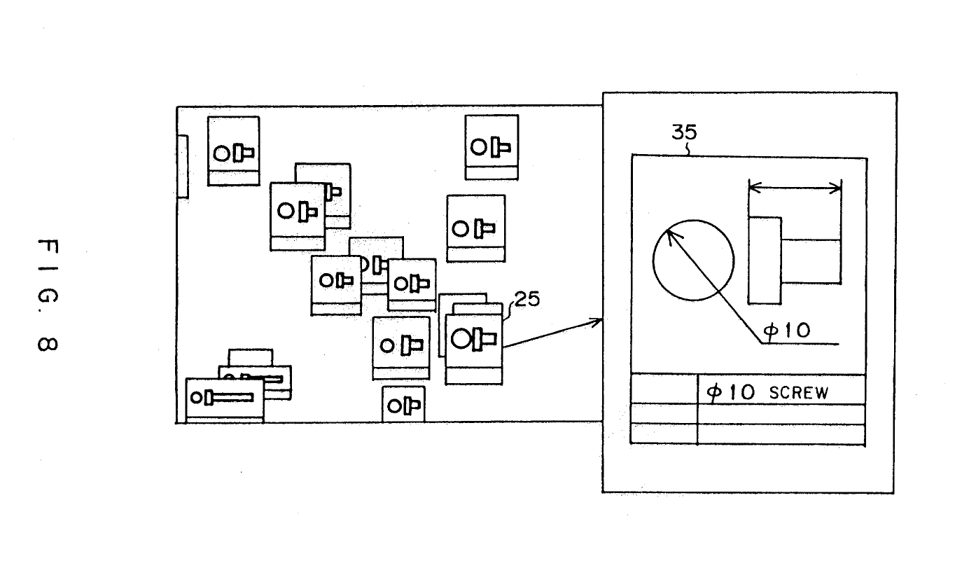

The drawing search support apparatus 31 displays on a screen, a virtual space 39 in which the icons 25 are arranged according to their arrangement information. A user changes his or her visual point in the displayed virtual space 39 using a pointing device, and searches for his or her desired icon 25, so that he or she can search for the drawing information 35. When the user 29 clicks the icon 25 of interest and accesses the original drawing information 35, the original drawing information 35 is displayed as shown in FIG. 8.

Furthermore, the drawing search support apparatus 31 can change the arrangement of the icons 25. In the re-arrangement of the icons 25, the icons 25 are classified to be arranged from various viewpoints by changing a feature amount that is allocated to each coordinate axis of the virtual space 39, as described in the following document.

Document 4:

PCT gazette WO 01/31503 A1, “Multimedia Information Sorting/Arranging Device and Sorting/Arranging Method”, 2001.

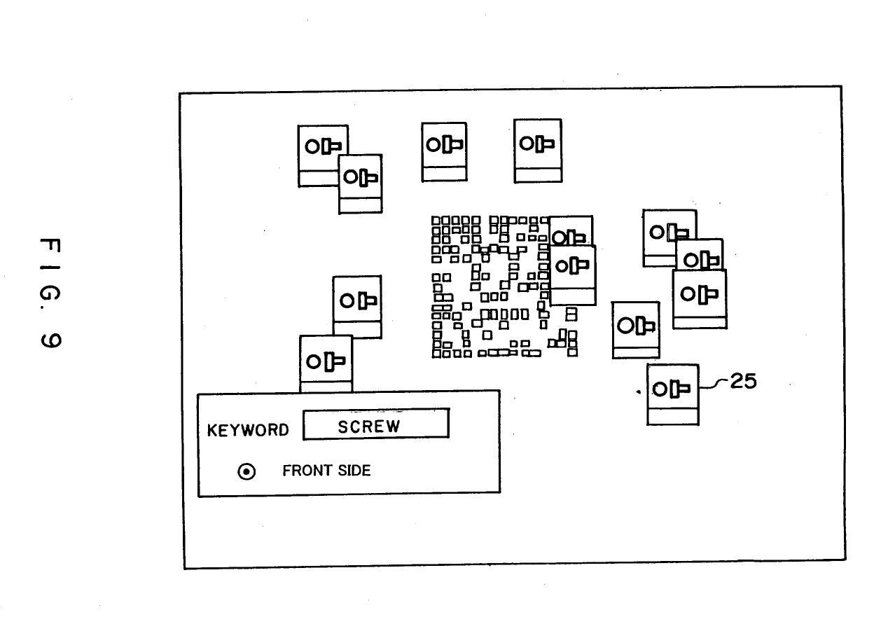

For example, the icon 25 can be re-arranged using a text characteristic instead of an image characteristic, as the feature amount 26 used for arrangement decision. As shown in FIG. 9, the user 29 inputs some keyword, compares the input keyword with the text attribute data included in the drawing information 35, and re-arranges the icons 25 corresponding to the drawing information 35 in such a way that the icon with a higher degree of matching appears closer to the user's visual point.

Furthermore, the information showing the content specific to the drawing information 35 can be added to the icon 25. For example, the drawing search support apparatus 31 identifies the type of the component in the drawing image using an image recognition technology, and depicts a label in which the type is described, in the vicinity of the icon 25. By adding the label to the icon 25, the drawing information of a different component, that has the similar outline, can be easily distinguished.

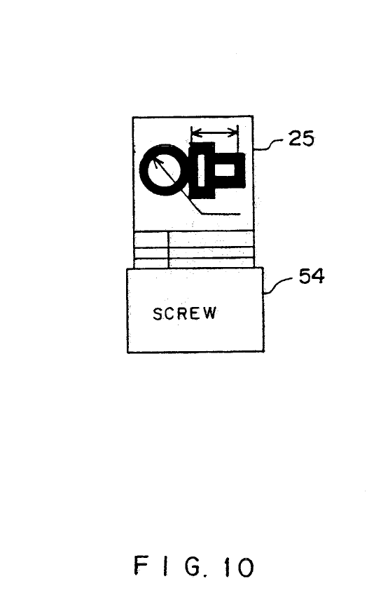

FIG. 10 shows an example of such a labeled icon. Here, a label 54 such as “a screw” is added to the icon 25 of the reduced image that is shown in FIG. 5. This label 54 functions as an auxiliary icon, and it is used for the display of the original drawing information 35 in a similar way as the icon 25.

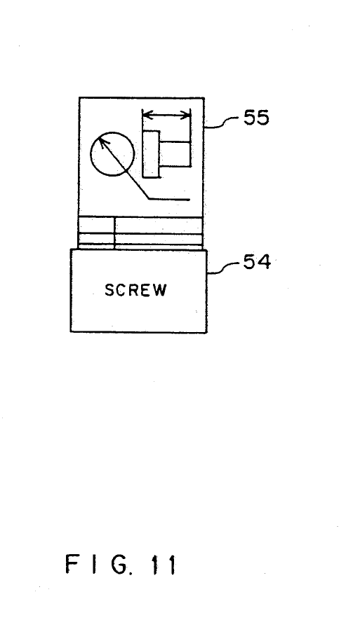

In the case that the type of a component is distinguished by a label, the line of the icon image does not necessarily have to be highlighted, and a simple reduced image of a drawing image may be used as shown in FIG. 11. An icon 55 shown in FIG. 11 is generated only by reducing the image of the original drawing information 35, and neither the extraction of the component drawing region 36 nor the highlighting of the drawing outline is performed. A label 54 is added to the icon 55 instead.

In the above-mentioned preferred embodiment explanation, an icon is generated by using a reduced image of the drawing information 35. In addition to this, it is also possible to store a set of predetermined icon images in an icon database, and to generate icons using this set.

In this case, a predetermined icon image that is prepared in advance for each type of component is stored in the icon database. In an icon generating process 23 in FIG. 3, the drawing search support apparatus 31 recognizes the type of a component in a drawing image using an image recognition technology, obtains the icon image corresponding to the identified type from the icon database, and allocates the obtained icon image to the corresponding drawing information 35.

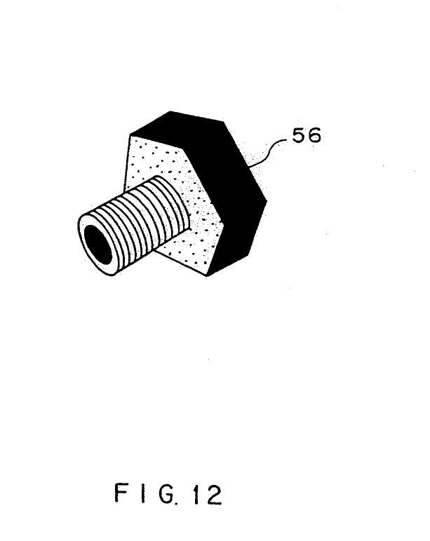

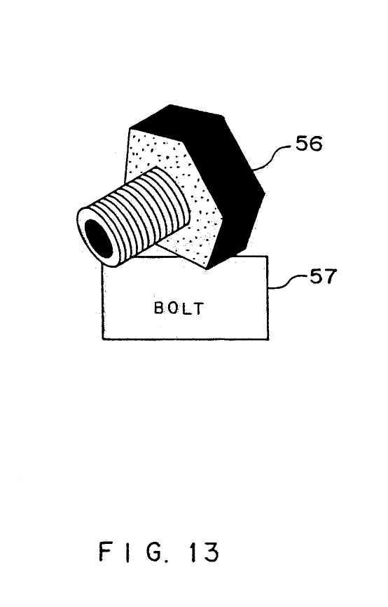

For example, if the recognition result is “a bolt”, an icon 56 (image symbolically showing the shape of a typical bolt) that has been assigned to “a bolt”, is allocated to the drawing information 35 and drawn as shown in FIG. 12. Furthermore, it is also possible to add a label that is shown in FIGS. 10 and 12, to the icon 56. FIG. 13 shows an example of adding a label 57 for a “bolt” to the icon 56.

In the case that the drawing search support apparatus 31 is equipped with a function for generating both the reduced image as shown in FIG. 5 and the predetermined icon as shown in FIG. 12, a user can select and display either icon.

In FIGS. 10, 11 and 13, a user can also add a label describing other information showing the content specific to the drawing information 35. For example, if the specific size (length, breadth, diameter, etc.), the material, the color, and related characteristics of a component are described using labels, the drawing information 35 of components of the same type can be easily distinguished.

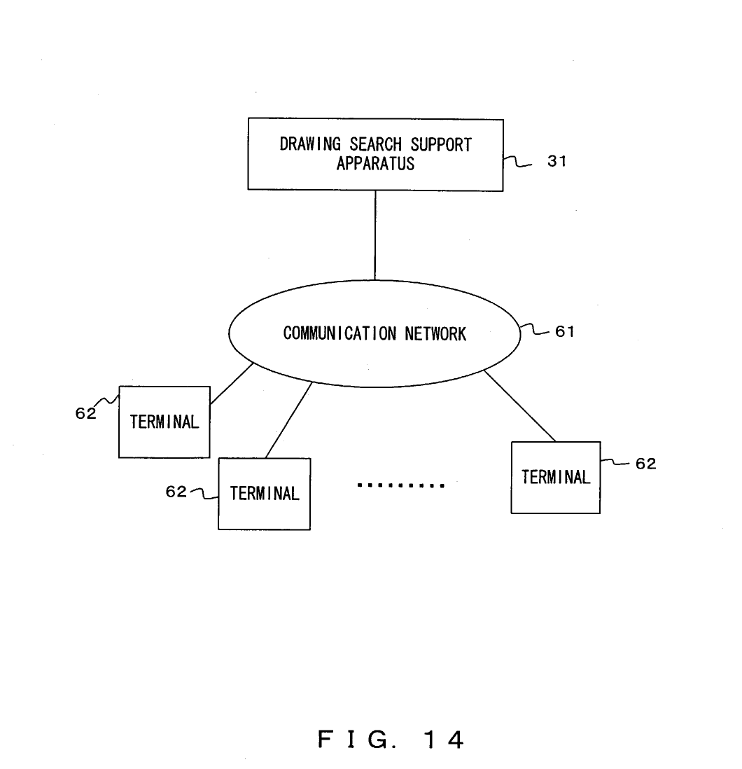

The drawing search support device 31 can receive a processing request from another apparatus through an arbitrary communication network. FIG. 14 shows such a network system. The system shown in FIG. 14 consists of the drawing search support apparatus 31, a user terminal 62, and a communication network 61 for connecting them.

A user instructs the drawing search support apparatus 31 to perform a drawing display process from the terminal 62, and designates the drawing information to be searched. Upon receipt of this instruction, the drawing search support device 31 generates the display data of the virtual space by generating and arranging the icon for each drawing information, and then transmits the display data to the terminal 62. Then, the terminal 62 displays the virtual space in which icons are arranged, on a screen using the received data. Consequently, this constitution enables many users to use the drawing search support apparatus 31.

Furthermore, the present invention can apply to arbitrary drawing information including a line drawing such as an electronic circuit drawing, a patent document, or a document including illustrations, in addition to the above-mentioned machine drawing.

The drawing search support apparatus 31 shown in FIG. 3 and the terminal 62 shown in FIG. 14 are constituted by using, for example, an information processing apparatus (computer) as shown in FIG. 15. The information processing apparatus shown in FIG. 15 is composed from a CPU (Central Processing Unit) 71, a memory 72, an input device 73, an output device 74, an external storage device 75, a medium driving device 76, and a network connection device 77. These devices are mutually connected by a bus 78.

The memory 72 includes, for example, a ROM (Read Only Memory), a RAM (Random Access Memory), etc., and it stores programs and data to be used for a process. The CPU 71 performs required processes by executing the programs using the memory 72.

The input device 73 is, for example, a keyboard, a pointing device, a touch panel, etc., and it is used for the input of instructions or information from a user. The output device 74 is, for example, a display device, and it is used for the display of a virtual space.

The external storage device 75 is, for example, a magnetic disk device, an optical disk device, a magneto-optical disk device, a tape device, etc. the information processing apparatus stores the programs and data in the external storage device 75, and loads them into the memory 72 to be used when necessary. The external storage device 75 is also used as the drawing database 33 shown in FIG. 3 or as an icon database for storing predetermined icon images.

The medium driving device 76 drives a portable recording medium 79 to access the recorded contents. As the portable recording medium 79, an arbitrary computer-readable recording medium, such as a memory card, a flexible disk, a CD-ROM (Compact Disk Read Only Memory), an optical disk, a magneto-optical disk, or the like is used. A user stores the programs and data in the portable recording medium 79, and loads them into the memory 72 to be used when necessary.

The network connection device 77 is connected to an arbitrary communication network such as a LAN (Local Area Network), etc., and performs data conversion associated with communications. The information processing apparatus receives the programs and data from another apparatus through the network connection device 77, and it loads them into the memory 72 to be used when necessary.

In the case of a network system shown in FIG. 14, the information processing apparatus shown in FIG. 15 corresponds to the drawing search support apparatus 31 or the terminal 62, and it communicates with the other through the network connection apparatus 77.

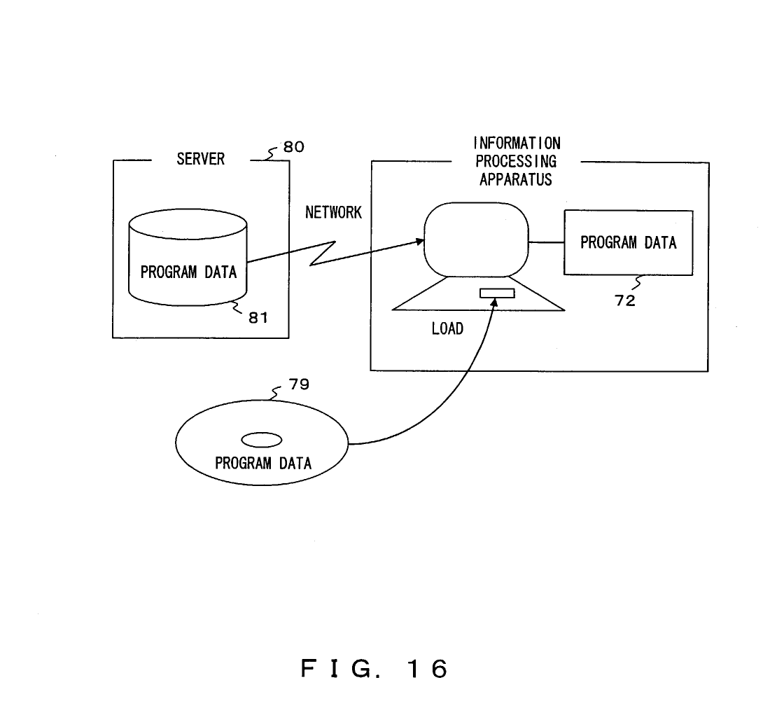

FIG. 16 shows a computer-readable recording medium for supplying a program and data to the information processing apparatus shown in FIG.15. The program and data that are stored in the portable recording medium 79 or a database 81 of a server 80 are loaded into the memory 72. At this time, the server 80 generates a propagation signal for propagating a program and data, and transmits the signal to the information processing apparatus through an arbitrary transmission medium on a network. Then, the CPU 71 executes the program using the data, and performs the required process.

According to the present invention, the desired drawing information can be efficiently searched for by roughly designating a drawing information group using a specific directory or a keyword, and by browsing the virtual space in which well-browsable icons are arranged.

What is claimed is:

1. A drawing search support apparatus supporting an operation of searching for desired drawing information from among a plurality of pieces of drawing information, comprising:
a generation device extracting a drawing region from among image data for each of the plurality of pieces of drawing information and generating an icon highlighting a line drawing in the extracted drawing region;
an arrangement device determining an arrangement position of each icon in a virtual space based on a feature amount of a corresponding piece of drawing information; and
a display device simultaneously displaying icons of the plurality of pieces of drawing information arranged in the virtual space.

2. The apparatus according to claim 1, further comprising a change device changing a visual point in the virtual space.

3. The apparatus according to claim 1, wherein the display device displays additional information showing a content that is specific to each piece of drawing information, in a vicinity of each icon.

4. The apparatus according to claim 1, further comprising a storage device storing a predetermined icon image prepared in advance for each type of drawing information, wherein
the generation device obtains an icon image corresponding to a type of each piece of drawing information, and generates an icon using the obtained icon image, and
the display device displays a virtual space in which icons of the plurality of pieces of drawing information generated using predetermined icon images are arranged, and displays additional information showing a content that is specific to each piece of drawing information, in a vicinity of each icon.

5. A drawing search support apparatus supporting an operation of searching for desired drawing information from among a plurality of pieces of drawing information, comprising:
a generation device extracting a drawing region from image data for each of the plurality of pieces of drawing information and generating an icon highlighting a line drawing in the extracted drawing region;
an arrangement device determining an arrangement position of each icon in a virtual space based on a feature amount of a corresponding piece of drawing information; and
a transmission device transmitting display data for simultaneously displaying icons of the plurality of pieces of drawing information arranged in the virtual space.

6. The apparatus according to claim 5, further comprising a change device changing a visual point in the virtual space.

7. A drawing search support apparatus supporting an operation of searching for desired drawing information from among a plurality of pieces of drawing information, comprising:
a storage device storing a predetermined icon image prepared in advance for each type of drawing information;
a generation device obtaining an icon image corresponding to a type of each of the plurality of pieces of drawing information from the storage device, and generates an icon using the obtained icon image;
an arrangement device determining an arrangement position of each icon in a virtual space based on a feature amount of a corresponding piece of drawing information; and
a display device simultaneously displaying icons of the plurality of pieces of drawing information arranged in the virtual space, and displays a content that is specific to each piece of drawing information, in a vicinity of each icon.

8. A computer-readable recording medium recording a program for a computer to support an operation of searching for desired drawing information from among a plurality of pieces of drawing information, the program causing the computer to perform:
extracting a drawing region from among image data for each of the plurality of pieces of drawing information;
generating an icon highlighting a line drawing in the extracted drawing region;
determining an arrangement position of each icon in a virtual space based on a feature amount of a corresponding piece of drawing information; and
simultaneously displaying icons of the plurality of pieces of drawing information arranged in the virtual space.

9. A computer-readable recording medium recording a program for a computer to support an operation of searching for desired drawing information from among a plurality of pieces of drawing information, the program causing the computer to perform:
extracting a drawing region from among image data for each of the plurality of pieces of drawing information;
generating an icon highlighting a line drawing in the extracted drawing region;
determining an arrangement position of each icon in a virtual space based on a feature amount of a corresponding piece of drawing information; and
transmitting display data for simultaneously displaying icons of the plurality of pieces of drawing information arranged in the virtual space.

10. A computer-readable recording medium recording a program for a computer to support an operation of searching for desired drawing information from among a plurality of pieces of drawing information, the program causing the computer to perform:
obtaining an icon image corresponding to a type of each of the plurality of pieces of drawing information from the storage device which stores a predetermined icon image prepared in advance for each type of drawing information;
generating an icon using the obtained icon image;
determining an arrangement position of each icon in a virtual space based on a feature amount of a corresponding piece of drawing information;
simultaneously displaying icons of the plurality of pieces of drawing information arranged in the virtual space; and
displaying additional information showing a content that is specific to each piece of drawing information, in a vicinity of each icon.

11. A propagation signal for propagating a program to a computer to support an operation of searching for desired drawing information from among a plurality of pieces of drawing information, the program causing the computer to perform:
extracting a drawing region from among image data for each of the plurality of pieces of drawing information;
generating an icon highlighting a line drawing in the extracted drawing region;
determining an arrangement position of each icon in a virtual space based on a feature amount of a corresponding piece of drawing information; and
simultaneously displaying icons of the plurality of pieces of drawing information arranged in the virtual space.

12. A propagation signal for propagating a program to a computer to support an operation of searching for desired drawing information from among a plurality of pieces of drawing information, the program causing the computer to perform:
extracting a drawing region from among image data for each of the plurality of pieces of drawing information;
generating an icon highlighting a line drawing in the extracted drawing region;
determining an arrangement position of each icon in a virtual space based on a feature amount of a corresponding piece of drawing information; and
transmitting display data for simultaneously displaying icons of the plurality of pieces of drawing information arranged in the virtual space.

13. A propagation signal for propagating a program to a computer to support an operation of searching for desired drawing information from among a plurality of pieces of drawing information, the program causing the computer to perform:
obtaining an icon image corresponding to a type of each of the plurality of pieces of drawing information from the storage device which stores a predetermined icon image prepared in advance for each type of drawing information;
generating an icon using the obtained icon image;
determining an arrangement position of each icon in a virtual space based on a feature amount of a corresponding piece of drawing information;
simultaneously displaying icons of the plurality of pieces of drawing information arranged in the virtual space; and
displaying additional information showing a content that is specific to each piece of drawing information, in a vicinity of each icon.

14. A drawing search method of searching for desired drawing information from among a plurality of pieces of drawing information, comprising:
extracting a drawing region from image data for each of the plurality of pieces of drawing information;
generating an icon that highlights a line drawing in the extracted drawing region;
determining an arrangement position of each icon in a virtual space based on a feature amount of a corresponding piece of drawing information;
simultaneously displaying icons of the plurality of pieces of drawing information arranged in the virtual space; and
searching for the desired drawing information using the displayed icons.

15. A drawing searching method searching for desired drawing information from among a plurality of pieces of drawing information, comprising:
storing, in a storage device, predetermined icon images prepared in advance for each type of drawing information;
obtaining, from the storage device, an icon image corresponding to a type of each of the plurality of pieces of drawing information;
generating an icon using the obtained icon image;
determining an arrangement position of each icon in a virtual space based on a feature amount of a corresponding piece of drawing information;
simultaneously displaying icons of the plurality of pieces of drawing information arranged in the virtual space;
displaying additional information showing a content that is specific to each piece of drawing information, in a vicinity of each icon; and
searching for the desired drawing information using the displayed icons and additional information.

16. A drawing search support apparatus supporting an operation of searching for desired drawing information from among a plurality of pieces of drawing information, comprising:
generation means for extracting a drawing region from among image data for each of the plurality of pieces of drawing information and generating an icon highlighting a line drawing in the extracted drawing region;
arrangement means for determining an arrangement position of each icon in a virtual space based on a feature amount of a corresponding piece of drawing information; and
display means for simultaneously displaying icons of the plurality of pieces of drawing information arranged in the virtual space.

17. A drawing search support apparatus supporting an operation of searching for desired drawing information from among a plurality of pieces of drawing information, comprising:
generation means for extracting a drawing region from image data for each of the plurality of pieces of drawing information and generating an icon highlighting a line drawing in the extracted drawing region;
arrangement means for determining an arrangement position of each icon in a virtual space based on a feature amount of a corresponding piece of drawing information; and
transmission means for transmitting display data for simultaneously displaying icons of the plurality of pieces of drawing information arranged in the virtual space.

18. A drawing search support apparatus supporting an operation of searching for desired drawing information from among a plurality of pieces of drawing information, comprising:
storage means for storing a predetermined icon image prepared in advance for each type of drawing information;
generation means for obtaining an icon image corresponding to a type of each of the plurality of pieces of drawing information from the storage means, and generates an icon using the obtained icon image;
arrangement means for determining an arrangement position of each icon in a virtual space based on a feature amount of a corresponding piece of drawing information; and
display means for simultaneously displaying icons of the plurality of pieces of drawing information arranged in the virtual space, and displays a content that is specific to each piece of drawing information, in a vicinity of each icon.
